(19) United States
(12) Patent Application Publication
(10) Pub. No.: US 2009/0011759 A1
(43) Pub. Date: Jan. 8, 2009

(54) FLEXIBLE NUMBERING IN MOBILE NETWORKS

(75) Inventors: Vladimir Alperovich, Plano, TX (US); Martin Reichelt, Frisco, TX (US)

Correspondence Address: ERICSSON INC., 6300 LEGACY DRIVE, M/S EVR 1-C-11, PLANO, TX, 75024, US

(73) Assignee: Telefonaktiebolaget LM Ericsson, Stockholm (SE)

(21) Appl. No.: 11/772,542

(22) Filed: Jul. 2, 2007

(51) Int. Cl. H04Q 7/20

(52) U.S. Cl. 455/433

(57) ABSTRACT

In a mobile telecommunications network, a subscriber having a primary subscription on a home mobile network registers one or more flexible subscriber numbers on a secondary network that are associated with the primary subscription. A caller places a call to a subscriber through a serving network using the flexible subscriber number. The flexible subscriber number is translated into a primary MSISDN and the call is connected to the subscriber so that roaming charges to the subscriber are minimized.

### FIELD OF THE INVENTION

This invention relates to mobile telecommunications and more particularly to systems and methods for allocating mobile numbers and providing communications on mobile networks.

### BACKGROUND OF THE INVENTION

Each mobile subscriber is assigned a mobile phone number. For example, in the US it is a country code plus 10 digit number comprised of the area code followed by a 7 digit locally assigned number.

There are several cases when the present numbering scheme is inadequate or insufficient. An example is the case of a family or a group of co-workers traveling from US to Europe. If one member of the group wants to call another (either using a cell phone or from a local land line such as a hotel phone), he or she would have to dial the full phone number of the called party. When such a call is placed, it will be first routed to the home country (i.e. US). Then it will be routed back to where the subscriber is actually roaming. The resulting charges are unpredictable and certainly much higher than necessary. As a result people that travel may be forced not to use the cell phone or purchase a separate prepaid card. Use of prepaid card results in revenue loss to the US operator plus the subscriber no longer has access to his or her regular phone service.

From a local user perspective, a problem with communications in the modern age is the volume of unsolicited or unwanted calls that a user may receive. In many situations, when placing an advertisement to sell a product or service, it is essential that a user provide their contact details including a phone number. Unfortunately, this leads to unsolicited calls even once the temporary need to advertise the number has expired.

### SUMMARY OF THE INVENTION

The present invention overcomes the abovementioned disadvantages by providing a flexible subscriber numbering system in which a subscriber can allocate additional mobile numbers to his or her subscription. The numbers may be allocated of a limited duration, or permanently. In addition the numbers may be allocated based on geographic location or a country. The subscriber may select the duration of the number allocation as well as the geographic number allocation using a simple web based interface.

Once the additional number or numbers are allocated the subscriber may be reached using those numbers. For example a person traveling to China may request a ‘Chinese’ number for the duration of the trip. When other members of his travel group wish to reach him, they will use this number to avoid additional charges.

In one embodiment of the disclosure, a mobile telecommunications network comprises a location register, at least one service control point and at least one database, wherein the location register stores a plurality of primary identifiers for a plurality of wireless telecommunications devices registered on the network, wherein the database stores an association between at least one of the primary identifiers and one or more secondary identifiers for the respective wireless telecommunications device, wherein the service control point receives a request for communication handling instructions from a secondary network, the request including a secondary identifier, wherein the service control point retrieves, from the database, a primary identifier associated with the secondary identifier included in the request, and wherein the service control point provides the communication handling instructions to the secondary network, the communication handling instructions being derived from the retrieved primary identifier.

In one embodiment of the disclosure, the mobile telecommunications network is a home mobile network.

In one embodiment of the disclosure, a mobile telecommunications network comprises a location register, wherein the location register stores at least one user subscription profile, wherein the user subscription profile includes a secondary identifier for a wireless telecommunications device and a pointer to a primary network storing a primary identifier for the wireless telecommunications device, wherein the network receives a communication request identifying a secondary identifier, wherein the network determines a primary network associated with the identified secondary identifier using a user subscription profile in the location register, wherein the network generates a request for communication handling instructions to the primary network, wherein the network receives communication handling instructions from the primary network, the communication handling instructions identifying a wireless telecommunications device, and wherein the network connects the communication request to the identified wireless telecommunications device in accordance with the received communication handling instructions.

In one embodiment of the disclosure, the mobile telecommunications network is a serving mobile network.

In one embodiment of the disclosure, a method for placing a communication to a wireless telecommunications device having a primary identifier associated with a primary network comprises, in the primary network, receiving a communication request from a secondary network, the communication request identifying a secondary identifier, in the primary network, translating the identified secondary identifier into a primary identifier and providing communication handling instructions derived from the primary identifier to the secondary network, the communication handling instructions instructing the secondary network to place the communication to the wireless telecommunications device.

In one embodiment of the disclosure, a method for placing a communication to a wireless telecommunications device having a primary device identifier registered on a primary network comprises, in a secondary network, receiving a communication request from a user, the communication request including a secondary identifier, in the secondary network, using the secondary identifier to determine the identity of the primary network, requesting communication handling instructions from the primary network, receiving communication handling instructions from the primary network, the communication handling instructions identifying a wireless telecommunications device and placing the communication to the identified wireless telecommunications device in accordance with the received communication handling instructions.

### BRIEF DESCRIPTION OF THE DRAWINGS

The invention will now be described with reference to exemplary embodiments in conjunction with the accompanying figures in which:

FIG. 1 represents a block diagram depicting a network arrangement in accordance with an embodiment of the disclosure;

FIG. 2 represents a flowchart in accordance with a an embodiment of the disclosure;

FIG. 3 represents a block diagram depicting a network arrangement in accordance with a further embodiment of the disclosure;

FIG. 4 represents a block diagram depicting a network arrangement in accordance with a further embodiment of the disclosure;

FIG. 5 represents a personal webpage including a link for requesting a flexible subscriber number in accordance with an embodiment of the disclosure;

FIG. 6 represents a network arrangement allowing substitution of a flexible subscriber number as the calling line identity in accordance with an embodiment of the disclosure; and

FIG. 7 represents an example of an interface in accordance with an embodiment of the disclosure.

### DETAILED DESCRIPTION OF THE INVENTION

The following embodiments describe systems and methods for connecting communications on a wireless network. While the embodiments refer specifically to voice calls from a caller, the skilled addressee will readily understand that the invention relates to the methods and systems for providing the communications, not the specific types of communications provided. Therefore, all manner of communications, including but not limited to voice, data, text message, VOIP, email, fax, multimedia etc and their equivalents are considered to be within the scope of the invention. Similarly, the present invention is considered to be independent of the type of mobile telecommunications device employed, with, for example, mobile telephones, pagers, personal digital assistants, WAP enabled devices etc being considered as equivalent and hereinafter referred to as mobile stations. In the following embodiments, the terms flexible subscriber number and temporary number may be used interchangeably.

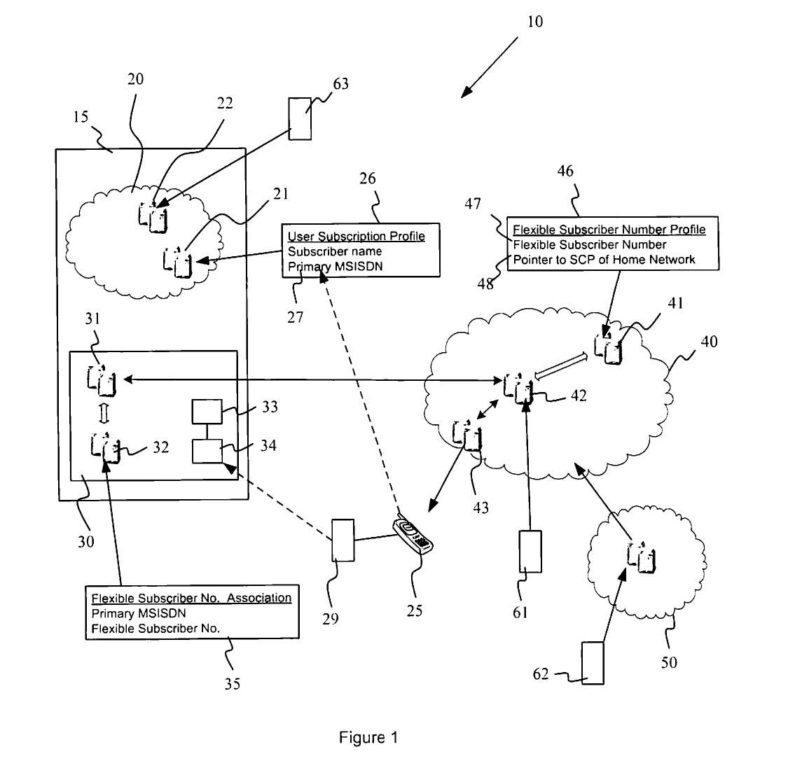

A telecommunications network arrangement in accordance with one embodiment of the invention is depicted in FIG. 1. The network arrangement 10 includes a primary network 15, a secondary network 40 and one or more peripheral networks 50. For the purposes of the description, the primary network 15 is described herein as a Home Network 15, and includes a Home Mobile Network 20 and an associated Intelligent Network 30. The Home Mobile Network 20 includes a Home Location Register (HLR) 21 and one or more Mobile Switching Centers (MSC)s 22, one or more of which may be a Gateway MSC (GMSC) as is well known in the art. The Intelligent Network 30 is associated with the Home Mobile Network 20 and is a service-independent network in which intelligent functions and services can be separated from the switching functions of the mobile network 20. The Intelligent Network 30 provides one or more Service Control Points (SCP)s 31, a database 32 and a web server 33 providing a web interface 34 to subscribers. The HLR 21 of the Home Network 15 stores primary subscription details for a mobile station 25 in a user subscription profile 26. The profile 26 includes a primary identifier 27 for the mobile station 25 in the form of a Mobile Station International ISDN Number (MSISDN). In accordance with known convention, a portion of the MSISDN 27 identifies the Home Mobile Network 20. Other details, such as subscriber name, etc may form part of the user subscription profile as is well known in the art. In other embodiments, the Intelligent Network 30 may include one or more network elements that perform similar functions to that of an SCP.

The secondary network 40 is described herein as a Serving Mobile Network and represents the mobile network in which the mobile station 25 is currently active. The Serving Mobile Network 40 includes a Home Location Register 41, a Gateway MSC 42 and a further MSC 43 for connecting to the mobile station 25.

In accordance with an embodiment of the present invention, the network arrangement 10 provides for one or more secondary identifiers, hereinafter referred to as flexible subscriber numbers, to be assigned to a mobile station having a primary MSISDN. In one embodiment, the flexible subscriber number has the form of a conventional MSISDN.

The flexible subscriber number includes a portion that identifies a secondary network to which the flexible subscriber number is registered and is stored in a flexible subscriber number profile in the HLR of that network. The secondary network may be the same mobile network as the primary MSISDN or a distinct network, such as the Serving Mobile Network 40 or a peripheral network 50. By way of example, a user subscription profile 46 containing a flexible subscriber number 47 is stored in the HLR 41 of the Serving Mobile Network 40.

Within the user subscription profile 46, an SCP identifier 48 points to the SCP 31 of the Intelligent Network 30 within Home Network 15. The flexible subscriber number of the Serving Mobile Network 40 is thereby associated with Home Network 15.

The database 32 connected with the Intelligent Network 30 stores an association between the primary MSISDN 27 and the flexible subscriber number 47. It is considered within the scope of the present invention that a primary MSISDN may be associated with any number of flexible subscriber numbers in any number of networks.

Using an interface 34 to the Intelligent Network 30, a subscriber 29 with mobile station 25 requests a flexible subscriber number for a specified mobile network, such as Serving Mobile Network 40. Upon allocation to the subscriber, the flexible subscriber number is associated with the subscriber's primary MSISDN and the association 35 is stored in the database 32 as described previously.

The flexible subscriber numbers may be pre-allocated from the serving network to the Home Network 15 or may be retrieved from the serving network at the time of registration. While a web interface 34 is described, the operator of the Home Network 15 may provide alternative registration interfaces through any suitable means such as a Wireless Application Protocol (WAP) through the subscriber's mobile station or other device, through an Interactive Voice Recognition system, or any suitable technology including any suitable technology supporting customer care and self care, via, for example, a customer care interface or a self care web interface

As well as specifying the network from which to receive the flexible subscriber number, e.g. by specifying a geographic region or country or by specifying a network which may include the home network, the user is also able to specify other details of the flexible subscriber number registration, such as the duration of the registration. In one embodiment, the user is able to select part or all of the flexible subscriber number. For example, a user may customize the number so that at least some of the digits are equivalent to the user's name, a user's initials, a product, a service or any relevant form within an acceptable number format.

The interface may also allow the subscriber to specify whether a code is required to complete the call and to select the code. The code provides an extension of the number thereby allowing the subscriber to be more selective in those people that can use the flexible subscriber number. Furthermore, since flexible subscriber numbers can be reassigned once a subscription to a number has expired, the code prevents calls being connected to a party who is later assigned with a particular flexible subscriber number.

In order to limit the calls that the subscriber receives, the interface may allow the subscriber to specify the number of calls that can be connected using the flexible subscriber number. The number selected may be in terms of a total, or a total per timeframe, e.g. per day, or may limit the times at which the flexible subscriber number can be used.

Rather than waiting for a subscription to a flexible subscriber number to expire, the interface can also allow the subscriber to actively release the association between the subscriber's primary MSISDN and any and all flexible subscriber numbers.

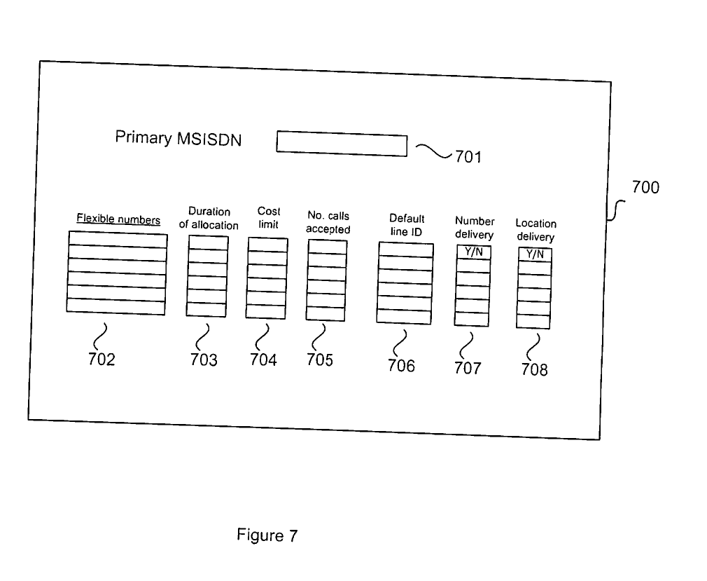

A sample interface 700 is shown in FIG. 7 showing fields for specifying the primary number 701, any flexible subscriber numbers 702, the duration of allocation 703, a cost limit 704, number of calls accepted 705, the default line identity for each number 706, a number delivery option 707 and a location delivery option 708. Each of these features is described in greater detail below.

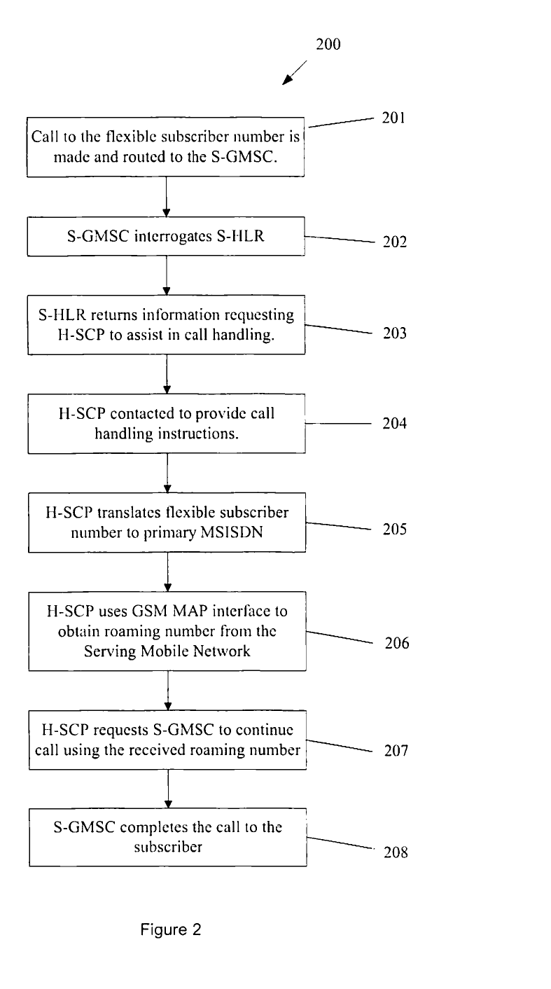

An operational example of the invention will now be described with reference to FIG. 1 and the flowchart 200 of FIG. 2. In the flowchart 200, the prefix “H−” refers to elements of the Home Mobile Network 15 while the prefix “S−” refers to elements of the Serving Mobile Network 40. In some embodiments, the Home Network and Serving Mobile Network may be the same. For the present example, mobile station 25 has a primary MSISDN stored in the HLR 21 of the Home Mobile Network 20, a flexible subscriber number stored in the HLR 41 of the Serving Mobile Network 40 and, therefore, a record 35 in the database 32 associating the flexible subscriber number with the primary MSISDN.

A caller 61 located within the Serving Mobile Network 40 initiates a call at step 201 to a mobile station 25 using the flexible subscriber number. The call is initiated through a Gateway MSC 42 of the Serving Mobile Network 40.

Because the flexible subscriber number appears to the Serving Mobile Network 40 as a local mobile number, the GMSC 42 interrogates the HLR 41 (step 202) of the Serving Mobile Network 40 in a conventional manner, in an attempt to retrieve call handling instructions for connecting the caller 61 to the mobile station 25. The HLR 41 acknowledges the association between the flexible subscriber number and the Home Network 15 and thus returns intelligent network information requesting the SCP 31 in the Home Network 15 to assist in the call handling (step 203). The Home Network SCP 31 is contacted and requested to provide call handling instructions (step 204). The request includes the flexible subscriber number, which is then translated by the SCP 31 into the primary MSISDN (step 205) using the record 35 in database 32. The SCP 31 (or a co-located GMSC) uses a standard GSM MAP interface, or other conventional protocol, to derive a roaming number from the Serving Mobile Network 40 using the primary MSISDN in a conventional manner (step 206). The SCP 31 then returns call handling instructions to the GMSC 41 of the Serving Mobile Network 40 including to continue the call through MSC 43 using the received roaming number (step 207). Thereafter, the GMSC 41 completes the call to the mobile station 25 of the subscriber 29 (step 208).

Because the call is not required to pass through any MSC outside of the Serving Mobile Network, the call is provided as a local mobile call.

When the call is first placed, the SCP 31 checks whether any subscription conditions have been met, such as whether an access code has been provided, or whether a maximum number of calls have been exceeded. If the call is determined to be allowable, the appropriate call handling instructions are provided to connect the call. If the call is deemed unallowable, an announcement conveying the appropriate reasons for disallowing the call may be provided to the caller.

In a further operational example, a second caller 62 uses the flexible subscriber number to access the Serving Mobile Network 40 from a distinct or peripheral network 50 outside of the Serving Mobile Network 40. Once contacted, the Serving Mobile Network 40 connects the call in the same manner as described above, that is, through a communication with the Service Control Point 31 of the Home Network 15 where call handling instructions are derived from the primary MSISDN translated from the flexible number.

In this case, because the caller connects from outside of the Serving Mobile Network 40, an inter-network charge, e.g. a local, domestic or international connection charge, may apply, depending on the location of the peripheral network 50. However any roaming charges will be avoided due to the elimination of the tromboning leg to the Home Network 15.

In a further operational example, a third caller 63 in the subscriber's home network, or any network, who attempts to contact the subscriber using the primary MSISDN, will be connected through an MSC 22 in the Home Network 15 in a conventional manner. Such a call will therefore be subject to standard roaming charges.

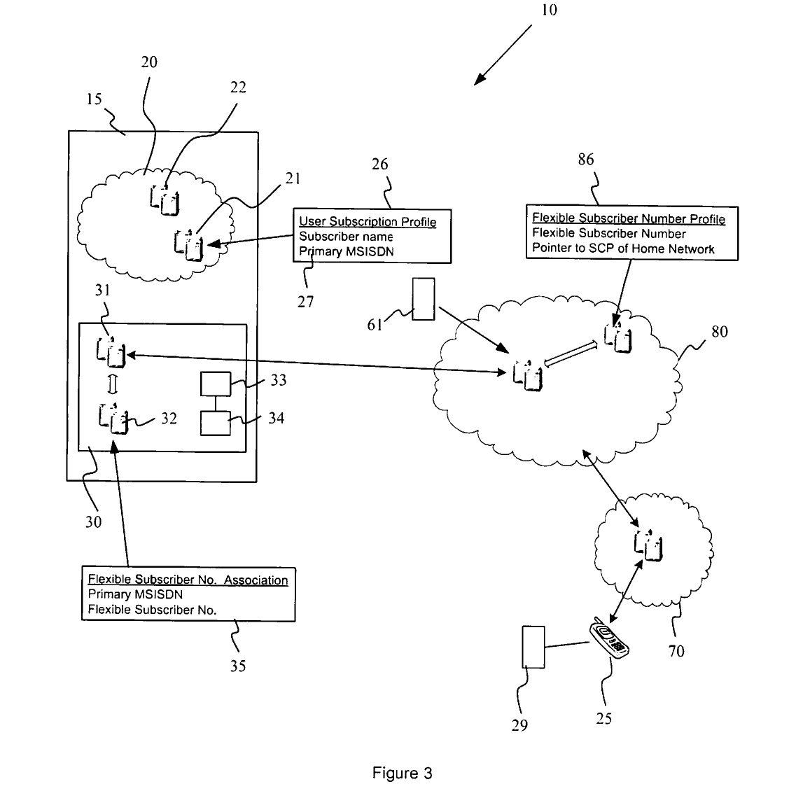

FIG. 3 shows an embodiment in which a subscriber 29 has a flexible subscriber number registered to a Peripheral Network 80 but has roamed to the Serving Mobile Network 70. When caller 62 places a local mobile call to Peripheral Network 80 using the flexible subscriber number, the Peripheral Network 80 contacts the Home Network 15 in the manner described above. The SCP 31 of the Home Network 15 uses a standard GSM MAP interface, or other conventional protocol, to derive a roaming number from the Serving Mobile Network 70 using the primary MSISDN and returns call handling instructions to the peripheral network 80. In this case, the caller 62 is charged a local mobile call but roaming charges from peripheral network 80 to the serving network 70 will apply for the subscriber 29. However, the roaming charges will generally be less than if the caller 62 had placed the call to the Home Network 15 using the primary MSISDN, for which, the caller 62 would also have incurred long distance charges to the Home Network 15.

In a specific example, a person, Rob who is a US resident, is traveling to France for business. After that he plans to holiday in Italy.

Rob has mobile service subscription in US. Before the trip Rob logs into the mobile operator's web site and requests two additional numbers for himself. For a small charge, e.g. a daily charge, he receives an additional number in Italy and another one in France for the duration of his trip.

When he arrives in France, Rob checks into a hotel. In the contact information he provides the ‘French’ number. When he arrives to work, Rob gives out his French number so that the local co-workers can call him without incurring the long distance charges.

Rob does the same when he arrives in Italy, this time he gives out the ‘Italian’ number. When Rob's French co-workers continue calling Rob on the French number, Rob, having roamed from the French network to the Italian network, will incur roaming charges. However, Rob's co-workers will only incur charges for a local mobile call. When the French number expires, people phoning the French number will receive a message, chosen by Rob, to indicate the expiration of the temporary flexible subscriber number. Rob's French co-workers can continue to contact Rob by using the Italian number, for which they only incur long-distance charges relating to the France-Italy leg.

Rob's sister calls from US using the main US allocated number, her call goes through in a normal fashion, for which Rob incurs standard US roaming charges.

When Rob returns home, he receives the regular phone bill. The daily fee is charged for the use of international numbers. The rest of the bill (airtime and roaming charges) are charged as if the primary MSISDN number was used.

Once Rob returns home and the ‘lease’ period for the flexible subscriber numbers expires, the numbers are placed in an inactive pool for a period of time before they can be assigned to another subscriber.

The above described embodiments have advantage by allowing the subscriber to save money while adding convenience as well as privacy.

In some embodiments of the invention, the subscriber may be provided with the option to disallow calls when roaming outside of the country or network to which the flexible subscriber number points. That is, the flexible subscriber number is only available while the subscriber is within the network associated with the flexible subscriber number. This may be coupled with an announcement option, in which an announcement is played to a calling party which will provide a number under which the called party (the subscriber) can be reached. This could be the original MSISDN or yet another secondary number that is associated with the network to which the subscriber has roamed.

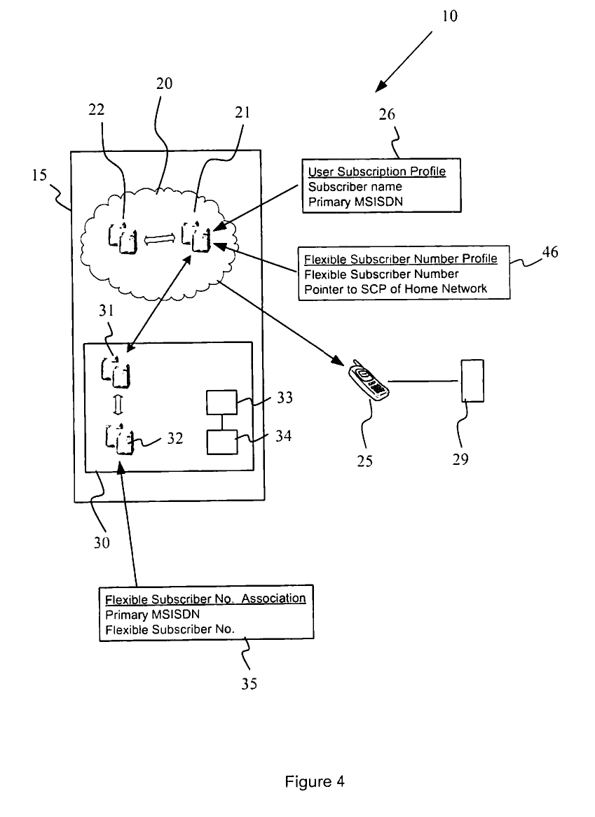

In a further embodiment of the invention shown in FIG. 4, the flexible subscriber number may be a number registered to the Home Network 15 and therefore used as an alias to protect the privacy of the primary MSISDN. In this example, the flexible subscriber number profile 46 for the flexible subscriber number is stored in the HLR 21 of the Home Mobile Network 15. A call placed through the home GMSC 22 by caller 63 using the flexible subscriber number, is handled internally by the SCP 31 to translate the flexible subscriber number to the primary MSISDN and then provide call handling instructions to the GMSC 21 for connecting the call to the mobile station 25 of the subscriber 29. Thus, a subscriber may elect to give out temporary numbers to some people, while keeping the main number private, for example for temporary job advertisements, for providing a work number distinct from a personal number, or for dating.

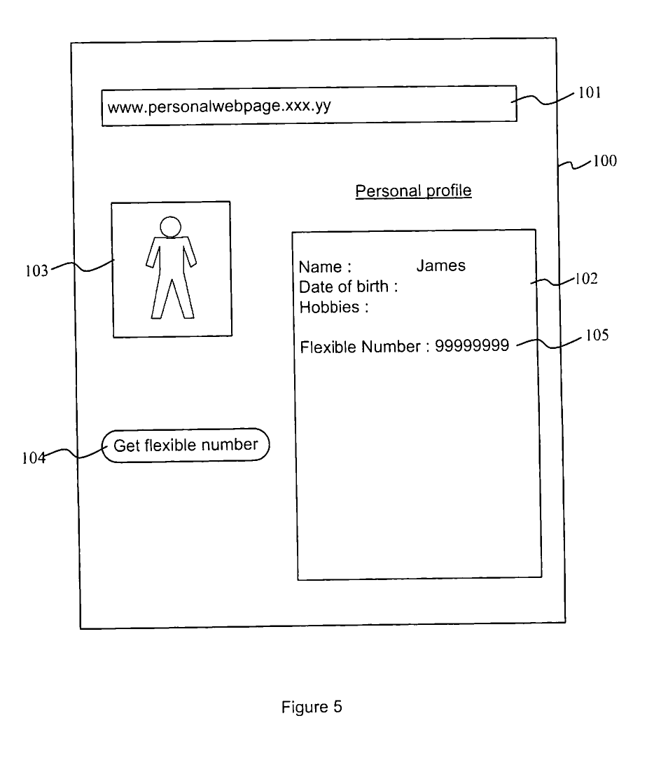

A specific example highlighting the temporary aliasing aspects provided by the above-mentioned embodiment of the invention, is the placing of personal advertisements, and the like. For example, with reference to FIG. 5, a person, James, places an ad or creates a personal web page 100 at a website 101, for example using a common site such as MySpace™. The webpage 100 may include, for example a personal profile 102 listing various personal details about James and may include a photo 103. He may want some of his new virtual friends to call him, for example to arrange meetings, yet he does not wish to publish his real phone number. From the same site, which may provide the interface 34 shown in FIG. 1, James clicks on a ‘get flexible number’ link 104 where he is allocated a temporary number. When allocated, an association between the allocated temporary number and James' primary number is stored in the Home Network. James then publishes the allocated temporary number 105 in his profile 102. His new friends may use the temporary number to call him. If any of them start abusing the privilege, or if James no longer requires the temporary number, James can use the interface 34 to provide a release request authorizing that the temporary number be dissociated from James' primary number. James may request multiple temporary numbers and he may publish some of them and give out some of them privately while keeping his ‘real’ or primary number private.

When James registers a temporary number, he may specify a duration for which the registration will be current. Once the registration expires, or James provides a release request, the temporary number returns to an un-allocated pool of numbers. However, the dissociated number is flagged in order to prevent it from being allocated for a period of time. This prevents a subsequent user to whom the number has been allocated from receiving calls that were intended for James.

In one embodiment, a temporary number may be associated with a code. A caller will be prompted for the code before being connected. This feature will help avoid reaching a wrong party after the temporary number has been re-cycled.

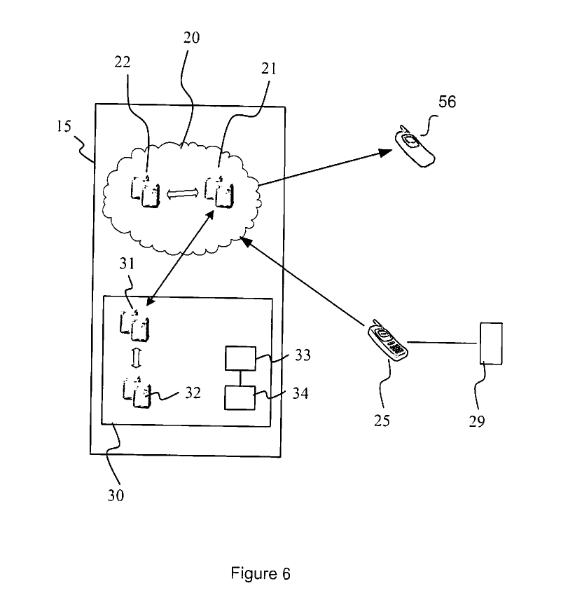

With reference now to FIG. 6, there is shown a further embodiment of the invention showing a call originating from the subscriber of the flexible subscriber number. Ordinarily, calls made by this subscriber would be identified to the called party by the MSISDN. To allow a subscriber to originate calls without sending the original MSISDN as line identification, logic can be added to the network nodes handling the call set-up on the originating side to exchange the original number with one of the secondary numbers. For example, as shown in FIG. 6, a call originating from the subscriber 29 is placed to the MSC 22 of the network 15. The call is routed through the SCP 31 where the number to be used as the line identity is determined. Once determined, the call, with the appropriate line identity is connected through to the called party device 71.

The line identity to be used for subscriber originating calls may be determined by prompting the subscriber when the call is placed to select an available number, which may be the primary MSISDN or any flexible subscriber number associated with that subscriber within the network. Other methods to determine the line identity to be used could be based on, but are not limited to, (i) USSD signalling to select one of the available MSISDNs as default for a number of subsequent calls, or only for the following call, (ii) a set of conditions which determines the MSISDN to be used as calling line ID, e.g. based on the called party number, a sub-string of the called party number (such as area code), or (iii) WAP/WEB interface or handset of the subscriber device 25 to select the MSISDN.

The substitution of the flexible subscriber number for the primary MSISDN may be applied irrespective of whether the subscriber is located within their home network or a separate serving network.

The SCP of the networks may be configured to associate the costs of each call made by the subscriber with either the primary MSISDN or the flexible subscriber number, depending on which number was used to connect the call. This may be appropriate where one of the subscriber's numbers is used for personal calls while another of the numbers is used for work related calls. This allows the subscriber to choose whether to have all calls billed to the primary account, or billed to the primary account and any flexible accounts separately.

While the invention has been described as providing interfacing between a home network and a serving network using a flexible numbering system, third party networks may also be used without exceeding the boundaries of the present invention. For example, communications between the serving network and the home network may be routed through a third party MSC. A third party may translate a first flexible subscriber number received from a serving network to a second flexible subscriber number determined by a profile on the third party network and then interrogate the home network using the second flexible subscriber number to determine the primary MSISDN stored on the home network.

While the flexible subscriber numbers of the embodiments have been described herein as having the form of an MSISDN, for the purposes of the invention, the flexible numbers need only identify a record stored in the network to which the flexible subscriber number is registered, with the record serving as a pointer to the Home Network where the primary subscription details are stored. The portion of a flexible subscriber number MSISDN that would normally identify a specific mobile station is not used for its conventional purpose. Therefore, other numbering formats may be employed.

Furthermore, the embodiments describe the translation of the flexible subscriber number to the primary MSISDN as occurring in the Home Network. It will be readily apparent to the skilled addressee that the translation may occur in the serving network or a peripheral network. In such an embodiment, a subscriber intending to travel to a region covered by a serving network may request one or more flexible numbers through an interface to the serving network, with a database in the serving network storing an association between the flexible number and the primary MSISDN and with the primary MSISDN providing the pointer to the Home Network.

The skilled addressee will appreciate from the foregoing, that different permutations and combinations exist for the location of the database that stores the association between the flexible subscriber number and the primary MSISDN, the location where the translation from the flexible subscriber number to the primary MSISDN is performed, and the network through which a subscriber interfaces in order to request and register the flexible subscriber numbers. All such permutations and combinations are considered to be within the scope of the invention.

In one embodiment, the association between the flexible subscriber number and the Home Network may be recorded at the time that the subscriber requests and registers the flexible subscriber number. That is, when the Home Network receives a request from a subscriber for a flexible subscriber number, the Home Network identifies a secondary or serving network from the request and requests a flexible subscriber number from the serving network, which the Home Network then allocates to the subscriber. The serving network may be specified in the subscriber request or the serving network may be determined by the Home Network from information in the subscriber request, such as a geographic indication.

In one embodiment, the flexible subscriber number may be pre-allocated to the Home Network, for example where a batch of flexible subscriber numbers are provided to the Home Network by the Serving Network, which may occur directly or through a third party re-seller.

In one embodiment, a local operator, which may be the Home Network operator or a third party operator could, for example, buy prepaid minutes associated with a block of flexible subscriber numbers wholesale from foreign operators. The local operator could then resell a prepaid number from the block of numbers to a local subscriber, at a markup (but less than the usual roaming fees), before the customer's foreign trip. The per-minute charge of the pre-paid number might be less than the usual roaming charge, but the operator can pre-sell a block of minutes—and possibly realize additional revenue on unused minutes. The prepaid number could also have an expiration date. If minutes remain unused by that date, they could then be resold by the operator. Thus, the invention provides opportunity for network operators to realize additional revenues.

It will appear from the foregoing, that an advantage of the embodiments herein disclosed is that an end-user may, at the user's discretion, be provided with a flexible registration in which one or more flexible numbers are allocated to the user's primary registration. The user is able to select flexible numbers from many networks and is also able to specify the duration of any flexible number registration.

While the above described network arrangements depicts such features as the HLR, SCP, MSCs and databases as being physically located within their respective networks, a distributed arrangement in which one or more of the elements are located remotely is also contemplated and within the scope of the invention.

Although embodiments of the present invention have been illustrated in the accompanying drawings and described in the foregoing description, it will be understood that the invention is not limited to the embodiments disclosed, but is capable of numerous rearrangements, modifications, and substitutions without departing from the spirit of the invention as set forth and defined by the following claims.

What is claimed is:

1. A mobile telecommunications network comprising:
a location register;
at least one service control point; and
at least one database;
wherein the location register stores a plurality of primary identifiers for a plurality of wireless telecommunications devices registered on the network;
wherein the database stores an association between at least one of said primary identifiers and one or more secondary identifiers for the respective wireless telecommunications device;
wherein the service control point receives a request for communication handling instructions from a secondary network, said request including a secondary identifier;
wherein said service control point retrieves, from said database, a primary identifier associated with the secondary identifier included in said request; and
wherein the service control point provides said communication handling instructions to said secondary network, said communication handling instructions being derived from said retrieved primary identifier.

2. A mobile telecommunications network according to claim 1 wherein said secondary network is external to said mobile telecommunications network and wherein said secondary identifier is registered on said secondary network.

3. A mobile telecommunications network according to claim 2 wherein said communication handling instructions are derived from the primary identifier by providing the primary identifier to a serving network and receiving a roaming identifier for the wireless telecommunications device from the serving network.

4. A mobile telecommunications network according to claim 3 wherein the serving network is associated with the secondary network.

5. A mobile telecommunications network according to claim 3 wherein the serving network is distinct from the secondary network.

6. A mobile telecommunications network according to claim 1 wherein said secondary network is within said mobile telecommunications network and wherein said request for communication handling instructions are generated within said mobile telecommunications network.

7. A mobile telecommunications network according to claim 6 wherein a user subscription profile for a secondary identifier is stored in said location register and wherein said user subscription profile provides a pointer to said service control point.

8. A mobile telecommunications network according to claim 1 wherein said secondary identifier is in the form of a Mobile Station International ISDN Number (MSISDN).

9. A mobile telecommunications network according to claim 1 further comprising an interface, wherein a subscriber may request a secondary identifier using said interface and wherein a secondary identifier provided in response to said subscriber request is associated with a primary identifier of the subscriber in said database.

10. A mobile telecommunications network comprising:
a location register;
wherein the location register stores at least one user subscription profile;
wherein the user subscription profile includes a secondary identifier for a wireless telecommunications device and a pointer to a primary network storing a primary identifier for said wireless telecommunications device;
wherein the network receives a communication request identifying a secondary identifier;
wherein the network determines a primary network associated with the identified secondary identifier using a user subscription profile in said location register;
wherein the network generates a request for communication handling instructions to said primary network;
wherein the network receives communication handling instructions from said primary network, said communication handling instructions identifying a wireless telecommunications device; and
wherein the network connects the communication request to said identified wireless telecommunications device in accordance with the received communication handling instructions.

11. A mobile telecommunications network according to claim 10 wherein said request for communication handling instructions includes said secondary identifier.

12. A mobile telecommunications network according to claim 10 wherein said pointer to said primary network includes said primary identifier, wherein the network translates said identified secondary identifier into an associated primary identifier and wherein the request for communication handling instructions includes said primary identifier.

13. A mobile telecommunications network according to claim 10 further comprising an interface, wherein a subscriber may request a secondary identifier using said interface and wherein an association between a secondary identifier provided in response to said subscriber request and a primary network of the subscriber is stored in said location register.

14. A method for placing a communication to a wireless telecommunications device having a primary identifier associated with a primary network, the method comprising:
in the primary network, receiving a communication request from a secondary network, the communication request identifying a secondary identifier;
in the primary network, translating the identified secondary identifier into a primary identifier; and
providing communication handling instructions derived from the primary identifier to the secondary network, said communication handling instructions instructing the secondary network to place the communication to the wireless telecommunications device.

15. A method according to claim 14 wherein the primary network comprises a database, wherein the database stores an association between a primary identifier of said wireless telecommunications device and one or more secondary identifiers for the respective wireless telecommunications device, and wherein translating the identified secondary identifier comprises retrieving said association from said database.

16. A method according to claim 14 wherein the communication handling instructions are derived from the primary identifier by providing the primary identifier to a serving network and receiving a roaming identifier for the wireless telecommunications device from the serving network.

17. A method according to claim 14 wherein said secondary network is within said primary network and wherein said request for communication handling instructions are generated within said primary network.

18. A method for placing a communication to a wireless telecommunications device having a primary device identifier registered on a primary network, the method comprising:
in a secondary network, receiving a communication request from a user, the communication request including a secondary identifier;
in the secondary network, using the secondary identifier to determine the identity of the primary network;
requesting communication handling instructions from said primary network;
receiving communication handling instructions from said primary network, said communication handling instructions identifying a wireless telecommunications device; and
placing the communication to the identified wireless telecommunications device in accordance with the received communication handling instructions.

19. A method according to claim 18 wherein the secondary network comprises a location register, wherein the location register stores at least one user subscription profile, wherein the user subscription profile stores an association between a secondary identifier and a pointer to a primary network, and wherein determining the identity of the primary network comprises retrieving said association from said location register.

20. A method according to claim 19 wherein said pointer to said primary network includes a primary identifier, wherein the network translates said identified secondary identifier into an associated primary identifier and wherein the request for communication handling instructions includes said primary identifier.

21. A system for allocating a temporary number to a user, the system comprising an interface for receiving a request from the user; wherein the system determines a primary number from the request; wherein the system allocates a temporary number to the user and wherein the system registers an association between the primary number and the allocated temporary number.

22. A system according to claim 21 wherein the system comprises a home network and wherein the allocated temporary number is selected from a plurality of temporary numbers allocated to the home network.

23. A system according to claim 22 wherein the allocated temporary number is registered to the home network.

24. A system according to claim 22 wherein the allocated temporary number is registered to a secondary network.

25. A system according to claim 21 wherein the system determines an identity of a secondary network and wherein the system allocates the temporary number by requesting a temporary number from the secondary network identified in the request.

26. A system according to claim 25 wherein the system determines the secondary network from a geographic region specified in the request.

27. A system according to claim 25 wherein the request specifies the secondary network.

28. A system according to claim 21 wherein the system dissociates an allocated temporary number from its associated primary number in response to a release request.

29. A system according to claim 28 wherein the interface receives said release request from a user.

30. A system according to claim 28 wherein the system stores a duration of a registration, and wherein the system generates the release request in response to determining that a duration of the registration has expired.

31. A system according to claim 28 wherein a dissociated temporary number is prevented from being re-allocated to a user for a period of time.
